(19) United States
(12) Patent Application Publication
(10) Pub. No.: US 2012/0151907 A1
(43) Pub. Date: Jun. 21, 2012

(54) FLANGED IMPELLER HUB

(75) Inventors: Alfredo Jimenez, Wooster, OH (US); Rashid Farahati, Copley, OH (US); Kris Rouch, Wooster, OH (US)

(73) Assignee: SCHAEFFLER TECHNOLOGIES GMBH & CO. KG, Herzogenaurach (DE)

(21) Appl. No.: 13/312,088

(22) Filed: Dec. 6, 2011

Related U.S. Application Data
(60) Provisional application No. 61/425,438, filed on Dec. 21, 2010.

(51) Int. Cl. F16D 33/18

(52) U.S. Cl. 60/330

(57) ABSTRACT

An impeller hub including a tube portion extending along an axis, the tube portion having an inner diameter and an outer diameter, wherein a longitudinal bore forms the inner diameter, a flange extending radially out from the tube portion, wherein the longitudinal bore through the tube portion and the flange are formed by a cold forming process.

### CROSS-REFERENCE TO RELATED APPLICATIONS

This application claims the benefit under 35 U.S.C. §119(e) of U.S. Provisional Application No. 61/425,438 filed Dec. 21, 2010, which application is incorporated herein by reference.

### FIELD OF THE INVENTION

The invention broadly relates to torque converters, more specifically to an impeller hub for a torque converter, and even more particularly to a seamless, flanged impeller hub for a torque converter.

### BACKGROUND OF THE INVENTION

Torque converters are known in the art commonly having an impeller hub for connection with a transmission assembly. One known type of impeller hub is a hub formed by forging. Since this hub must be created by forging, it is very costly to produce. For example, see United States Patent Publication No. 2009/0155078 (Heeke et al.), which Patent Publication is hereby incorporated by reference in its entirety. Forged hubs are made with a very large radial flange in order to strengthen the connection of the hub to the impeller shell, as discussed in more detail below. A second type of impeller hub is a seamed tube hub, which is formed by rolling a long, flat piece of steel into a tube, and welding down the seam. However, this hub is not very strong because of the seam down its length and also because it lacks a flange.

Another type of impeller hub is a seamless tube hub, which is formed by an extrusion-type process. Although stronger than the seamed tube hub, the seamless hub is not nearly as strong as the forged hub, because the seamless hub also lacks a flange. Thus, when welded to the impeller shell, the tube hub is essentially perpendicular with respect to the impeller shell, with a weld formed about the tube along this perpendicular contact point.

Disadvantageously, the location of the weld is also the point about which the tube hub bends or deflects when subjected to forces during operation of the torque converter on the hub. For example, the torque converter may vibrate or wobble slightly during normal operation due to slight misalignment of the torque converter between an engine and transmission. Accordingly, the weld is subjected to a large bending moment created by forces exerted on the hub. The flange of the forged hub offsets the weld position so that bending does not occur directly at the weld, thereby reducing the stress in the weld. Furthermore, by moving the weld outwards in the radial direction, the surface area covered by the weld is increased, thereby increasing the overall strength of the welded joint. Thus, what is desired is a hub having a flange, but manufacturable by a process less costly than forging.

### BRIEF SUMMARY OF THE INVENTION

The present invention broadly comprises an impeller hub including a tube portion extending along an axis, the tube portion having an inner diameter and an outer diameter, wherein a longitudinal bore forms the inner diameter, a flange extending radially out from the tube portion, wherein a flange diameter of the flange is at most 30% larger than the outer diameter. The longitudinal bore through the tube portion, the flange, or both, are formed by a cold forming process. In one embodiment, the outer diameter of the tube portion is at most approximately 50 mm. In one embodiment, the impeller hub is manufactured from SAE 1035 or SAE 10B35 steel. In one embodiment,

The current invention also broadly comprises a torque converter comprising an impeller hub according to the above paragraph welded to an impeller shell. In one embodiment, the impeller hub is welded to the impeller shell such that the inner diameter of the tube portion of the impeller hub is aligned with an inner circumferential surface of the impeller shell. In one embodiment, the impeller hub is welded to the impeller shell such that a radial surface of the flange is aligned with an inner radial surface of the impeller shell.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a cross-sectional view of a torque converter having a mini-flange impeller hub welded to an impeller shell in a first embodiment;

FIG. 2 is a cross-sectional view of a mini-flange impeller hub welded to an impeller shell in a second embodiment; and, FIG. 3 is a cross-sectional view of a mini-flange impeller hub.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims. It is also understood that any reference to axial, radial, or circumferential directions, surfaces, or properties is made with respect to the axis of rotation shown in the drawings, indicated generally as axis A. “Cold forming” and/or “cold working” is used in accordance with the commonly understood definition of the term, that is, to generally mean that the forming is performed at ambient or room temperature, or, more specifically, at a lower temperature than the re-crystallization temperature of the material being formed.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

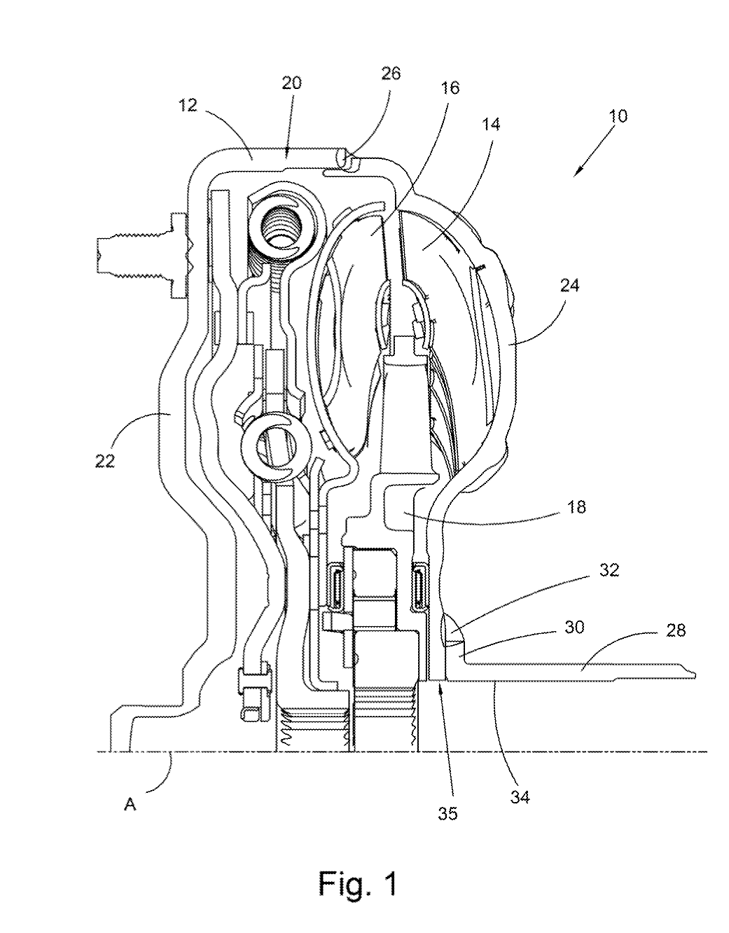

Referring now to the figures, FIG. 1 shows torque converter 10 arranged, for example, with cover 12 connected to an engine or other torsional input (not shown), the torque converter also having impeller 14, turbine 16, stator 18, and vibration damper 20 for hydraulically transferring torque through the torque converter. These components are shown for purposes of discussion, and could be replaced by any type or style of cover, impeller, turbine, stator, and/or vibration damper known in the art, and in some embodiments, some of these components may not even be included.

Cover 12 is formed by two cover portions, namely, engine side cover portion 22 and impeller shell portion 24. That is, cover portion 24 also forms a shell for impeller 14. Cover portions 22 and 24 are connected together, such as via weld 26. Impeller hub 28, which includes mini-flange 30, is affixed to impeller shell 24 via weld 32. In the embodiment of FIG. 1, mini-flange 30 is matingly engaged against the outer radial surface of impeller shell 24, such that inner circumferential surface 34 of hub 28 is aligned with inner circumferential surface 35 of impeller shell 24 for forming a substantially smooth opening for receiving input and/or stator shafts from a transmission for coupling with the output of damper 20 and stator 18, for example.

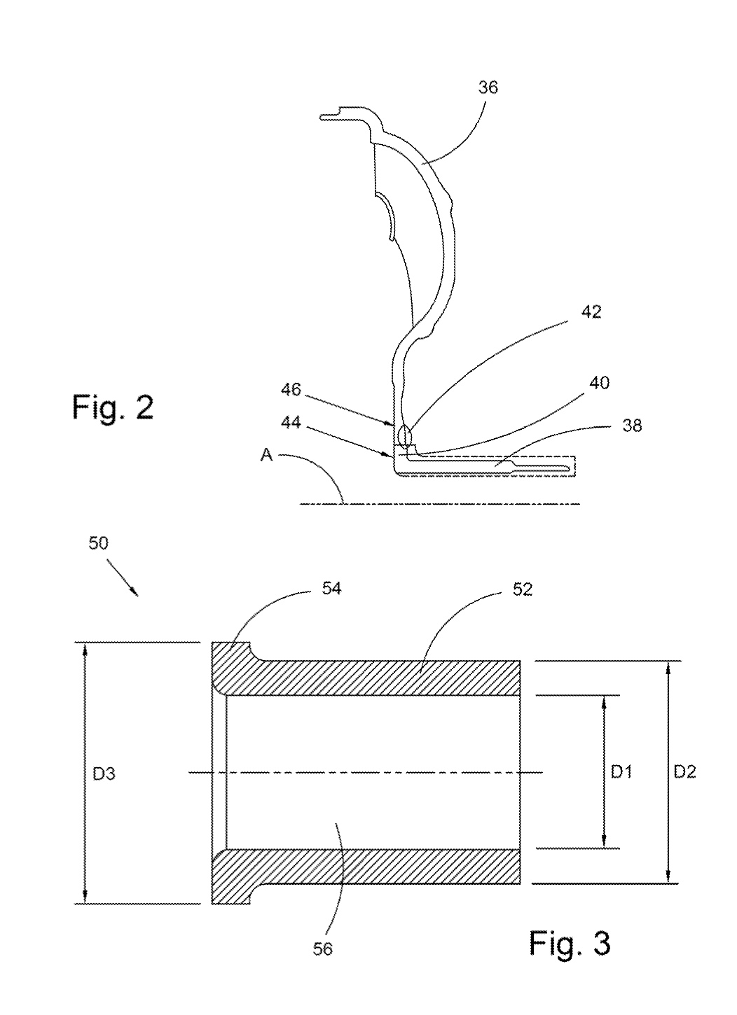

A second arrangement is shown with respect to the embodiment of FIG. 2. Impeller shell 36, which substantially resembles shell 24, is shown welded to impeller hub 38, which substantially resembles impeller hub 28, in that hub 38 includes mini-flange 40. Also like hub 28, hub 38 is secured to impeller shell 36 via weld 42, however, the placement of the hub with respect to the impeller shell is different. Specifically, hub 38 is arranged with respect to impeller shell 36 such that radial surface 44 of the hub is not engaged matingly against the outer radial surface of the impeller shell, but instead so that radial surface 44 is aligned with inner radial surface 46 of impeller shell 36.

Impeller hub 50 is shown in FIG. 3 as a general example of a hub according to the current invention. Hub 50 includes tube portion 52, with flared end or mini-flange 54, which generally resembles both of mini-flanges 30 and 40. Bore 56 is formed down the middle of the hub, such as for enabling a transmission input shaft to run therethrough. Hub 50 has inner tube diameter D1 and outer tube diameter D2. The inner tube diameter is defined by the bore down the middle of the tube. Flange diameter D3 defines the outer diameter for flange 54.

Due, for example, to the process of cold forming, diameter D3 is maximally formed as being approximately 30% larger than outer tube diameter D2. Thus, the term “mini-flange” is used herein, because the flange of forged hubs used in prior art torque converters are much larger than the mini-flanges of the current invention, where the forged hubs have a flange diameter approximately at least 50% larger than the outer tube diameter. Steel is commonly used for impeller hubs, and it has been found that the material for manufacturing mini-flange hubs according to the current invention should have low carbon content, such as SAE1035 or SAE 10B35 in order to sufficiently undergo the cold forming process.

Advantageously, as discussed above, the inclusion of mini-flanges 30, 40, or generally 54, results in the weld, such as welds 32 and 42, becoming moved radially outward with respect to the position at which the weld would have been located for a seamless tube hub. Since the weld is formed in a circular pattern about the outer circumference of the hub, moving the location of the weld radially outward results in the size of the weld bead to increase, thereby increasing the overall strength of the welded connection between the impeller shell and the hub.

Furthermore, moving the weld location radially outward moves the weld away from the point that the hub bends with respect to the impeller shell when the hub is subjected to forces, such as during vibration of the torque converter during operation. Instead, the bending moment is experienced most severely in the hub at the corner where the mini-flange meets the tube portion.

It should be noted that using larger diameter seamless tube hubs also results in an increase in size, and therefore strength, of the weld bead in prior art systems. As a result, the current invention hub is generally more important for use in smaller sized torque converters, which have smaller weld beads. For example, it has been found that seamless tube hubs which are approximately over 50 mm in outer diameter have welds which are sufficiently strong to handle normal operating conditions. As a result, the current invention hub has been found to provide the greatest advantage when formed on impeller hubs approximately less than 50 mm in outer diameter.

One cold forming process of manufacturing hub 50 is described generally below. The process starts with a cylindrical rod or wire that is cut to the appropriate length. A cavity is formed into the rod such that the part substantially resembles a cup, and is substantially U-shaped in cross-section. Excess material may be included proximate the base of the cup-shaped part, such that a lip is next formed about the base of the part using the excess material. Thus, the part substantially resembles a cup with a disc-like lip or projection extending from the cup. Next, finished hub 50, as shown in FIG. 3, is formed by extending the cavity fully through the hub for forming longitudinal bore 56 through tube portion 52. The lip formed about the base of the cup-shaped part is thus arranged as mini-flange 54 on hub 50. The process is performed in a cold forming operation involving a press and a die set, for example, where the part transitions between dies so that a cut rod or wire enters the press and the finished hub comes out.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. An impeller hub comprising:
a tube portion extending along an axis, said tube portion having an inner diameter and an outer diameter, wherein a longitudinal bore forms said inner diameter;
a flange extending radially out from said tube portion;
wherein a flange diameter of said flange is at most 30% larger than said outer diameter.

2. The impeller hub recited in claim 1, wherein a wherein said longitudinal bore through said tube portion, said flange, or both, are formed by a cold forming process.

3. The impeller hub recited in claim 2, wherein said outer diameter of said tube portion is at most approximately 50 mm.

4. The impeller hub recited in claim 3, wherein said impeller hub is manufactured from SAE 1035 or SAE 10B35 steel.

5. A torque converter comprising an impeller hub according to claim 1 welded to an impeller shell.

6. The torque converter recited in claim 5, wherein said impeller hub is welded to said impeller shell such that said inner diameter of said tube portion of said impeller hub is aligned with an inner circumferential surface of said impeller shell.

7. The torque converter recited in claim 5, wherein said impeller hub is welded to said impeller shell such that a radial surface of said flange is aligned with an inner radial surface of said impeller shell.
